(19) United States
(12) Patent Application Publication
(10) Pub. No.: US 2022/0393234 A1
(43) Pub. Date: Dec. 8, 2022

(54) Bi-electrolyte displacement battery

(71) Applicant: Pure Lithium Corporation, Charlestown, MA (US)

(72) Inventors: Donald R. Sadoway, Cambridge, MA (US); Paul J. Burke, Framingham, MA (US)

(21) Appl. No.: 17/832,336

(22) Filed: Jun. 3, 2022

Related U.S. Application Data
(60) Provisional application No. 63/197,091, filed on Jun. 4, 2021.
(60) Provisional application No. 63/221,546, filed on Jul. 14, 2021.

(51) Int. Cl. H01M 10/0565; H01M 4/134; H01M 4/1395; H01M 4/04; H01M 10/39; H01M 10/54; C08G 65/00

(52) U.S. Cl. CPC H01M 10/0565; H01M 4/134; H01M 4/1395; H01M 4/0416; H01M 10/399; H01M 10/54; C08G 65/002; H01M 2300/0091; H01M 2004/028

(57) ABSTRACT

An electropositive metal electrode coated by an ion-selective conformable polymer provides the negative electrode and the solid-state electrolyte for a rechargeable bi-electrolyte displacement battery that further includes a molten salt electrolyte having a melting temperature below 140° C. interposed between the conformable polymer coating and a positive electrode. Suitable electropositive metals include lithium, sodium, magnesium, and aluminum and the molten salt incorporates a soluble salt of the metal of the negative electrode. Positive electrodes may incorporate metals including Fe, Ni, Bi, Pb, Zn, Sn, and Cu, and thanks to the ion-selective conformable solid-state electrolyte the molten salt is able to incorporate a soluble salt of the metal of the positive electrode. The conformable polymer-coated electropositive metal electrode may be manufactured by a process involving electroplating electropositive metal through a conformable polymer-coated conductive substrate. The conformable polymer-coated conductive substrate may be prepared by coating the conductive substrate in a conformable polymer solution followed by evaporating the solvent. Alternatively, an electropositive metal electrode may be coated directly with the conformable polymer.

### CROSS-REFERENCE TO RELATED APPLICATIONS

This patent application claims the benefit of U.S. Provisional Patent Application No. 63/197,091 filed Jun. 4, 2021, and U.S. Provisional Patent Application No. 63/221,546 filed Jul. 14, 2021. These applications are hereby incorporated, in their entirety, by reference.

### TECHNICAL FIELD

The present invention relates to the manufacture of rechargeable metal batteries using inorganic molten salts and electropositive metal electrodes, including metal electrodes manufactured from lithium, sodium, magnesium and aluminum.

### BACKGROUND ART

Lithium ion batteries (LIBs) dominate the automotive and small electronics market. LIBs contain no metallic lithium present as such. The negative electrode comprises a carbon host for neutral lithium which is contained therein. In the electrolyte and in the positive electrode lithium is present only as the ion. Such batteries are attractive for their high energy density compared to that of other rechargeable batteries and for their ability to operate over multiple charge/discharge cycles. However, the organic electrolytes typically used in LIBs are flammable and are a safety hazard if the batteries overheat. Moreover, lithium-ion batteries typically use intercalation-type positive electrodes, which suffer from decrepitation, leading to capacity fade.

In lithium metal batteries (LMBs) the negative electrode comprises metallic lithium. Because LMBs with lithium metal as the negative electrode have intrinsically higher capacity than LIBs, they are the preferred technology for primary batteries. Moreover, since LMBs can be manufactured in the fully charged state, they do not require the lengthy formation process needed for LIBs. However, poor cycle life, volumetric expansion, and safety concerns relating to shorts resulting from dendrite formation and the potential for violent combustion of flammable organic electrolytes have limited their practical use as rechargeable batteries.

A limitation of both LIBs and LMBs is that lithium is a limited natural resource, widely dispersed on the earth, but typically in low concentration. Moreover, lithium availability and cost depend on politically fragile supply chains. Also, while a high specific capacity is desired for automotive applications, for applications such as energy storage, cost is the more important factor. For such applications, battery technologies based on materials that are cheaper and more highly abundant than the materials used in lithium batteries are desirable.

Improved rechargeable battery technologies, including LMB technologies and technologies that use cheap and abundant materials are needed to meet the ever increasing electrical energy storage needs of the 21st century. Desired improvements include better electrochemical efficiency, lower cost, increased cycle life, and enhanced safety profile.

### SUMMARY OF THE EMBODIMENTS

Molten salts provide an electrolyte alternative to organic electrolytes, with non-flammability and high ionic conductivities as attractive attributes. Inorganic molten salts can make use of common inexpensive materials and can be formulated to have low melting temperatures. However, the choices of inorganic molten salts that can serve as solvents for the cations of electropositive metals such as Li, Na, Mg, and Al, are limited by the low, i.e., cathodic, reduction potentials of these ions compared to those of other metallic cations. In order to have low melting temperatures, inorganic molten salts typically must incorporate the salts of metals that are more noble (less electropositive) than Li, Na, Mg, and Al, and will thus preferentially electroplate compared to these ions during battery recharging.

Molten salts incorporating complex organic cations—such as the 1-ethyl-3-methylimidazolium (EMIM) cation—partially address the problem of preferential electroplating, but are significantly more expensive, and have decreased ionic conductivities compared to those of inorganic molten salts. Such organic cation-based molten salts also have very low Tins, allowing them to be liquid at room temperature. Such room temperature molten salts are also called ionic liquids.

However, ionic liquids incorporating complex organic cations are not favorable for electrochemical cells with metal positive electrodes. When soluble metal ions are released from the positive electrode, they can be transported to the negative electrode, where they preferentially electroplate.

Solid state electrolytes (SSEs) can also replace organic electrolytes and thus ameliorate safety concerns for lithium batteries. However, SSEs can also result in high impedance at the positive electrode, thereby reducing output voltage and hence battery efficiency. Moreover, if such SSEs are ceramic, cell geometries are limited by the brittleness of the fragile material. Conformable polymers as defined herein are amorphous viscoelastic polymers that provide an alternative SSE, with the mechanical properties of solids but having the ability to shrink and adapt to volume changes of an underlying substrate, while continuing to coat the substrate.

Bi-electrolyte electrochemical cells are electrochemical cells that incorporate both inorganic molten salts and ion-selective SSEs. One such bi-electrolyte electrochemical cell is the so-called ZEBRA electrochemical cell, which incorporates sodium as the negative electrode, as described in U.S. Pat. No. 4,546,055. However, the molten salts of the ZEBRA cell have Tₘs that are above the melting point of sodium, and the Zebra cell incorporates a solid ceramic electrolyte of β″-alumina that contains the molten sodium that is present during cell operation. Accordingly, cracks and defects in the SSE can lead to catastrophic cell failure, with the release of highly reactive molten sodium. Although in principle a conformable polymer SSE could be incorporated into such a bi-electrolyte cell, because molten salts at higher temperatures are highly corrosive, such conformable polymer SSEs over time would be subject to chemical attack as well as thermal degradation, again potentially leading to catastrophic cell failure.

According to embodiments of the instant invention, a bi-electrolyte electrochemical cell is disclosed that incorporates a low Tₘ inorganic molten salt and a conformable polymer ion-selective SSE coating the negative electrode. Because the cell operates at low temperature, the electropositive metal of the negative electrode is in the solid phase, so that there is no danger of release of molten reactive metal. The embodied conformable polymer SSE coating expands or contracts to accommodate negative electrode volume changes.

In some embodiments, the electrochemical cell of the instant invention incorporates an electropositive electrode made from a cheap and abundant metal such as sodium, magnesium, and aluminum. A second, less electropositive metal can be used for the positive electrode, which is advantageous from a cost perspective, and also because it eliminates the need to use decrepitation-prone intercalation-type positive electrodes.

In accordance with embodiments of the invention, a rechargeable metal displacement battery is disclosed which includes a negative electrode, the negative electrode having a conductive substrate coated with a layer of a first metal in elemental form, the layer of the first metal having an inner face and an outer face, the inner face contacting the conductive substrate. The rechargeable metal battery further includes a positive electrode made from a second metal, and a solid electrolyte comprising a conformable polymer that preferentially conducts ions of the first metal compared to ions of the second metal, and that coats the outer face of the layer of the first metal. In preferred embodiments, the rechargeable metal battery further includes a molten salt electrolyte, the molten salt electrolyte being a mixture of inorganic salts including a first salt of the first metal and a salt of the second metal, wherein the melting temperature of the molten salt electrolyte is less than 140° C., wherein the molten salt electrolyte is disposed between the solid electrolyte and the positive electrode, and is in direct physical contact with both the solid electrolyte and the positive electrode, and wherein the first metal is more electropositive than the second metal.

In preferred embodiments, the conformable polymer is a graft or block copolymer with a first segment and a second segment, with each segment above its respective glass transition temperature, T_{g}, the first segment being formed from groups configured to solvate a second salt of the first metal and the second segment being immiscible with the first segment, wherein the second salt of the first metal is dispersed within the solid electrolyte. In some such embodiments, the first segments of the block or graft copolymer comprise poly(oxyethylene)ₙ side chains, where n is an integer between 4 and 20.

In preferred embodiments, the first metal is selected from the group consisting of an alkali metal, an alkaline earth metal, and aluminum. In preferred embodiments, the second metal is selected from the group consisting of Fe, Ni, Bi, Pb, Zn, Sn, and Cu. In some embodiments, the mixture of inorganic salts includes one or more salts selected from the group consisting of aluminum salts, titanium salts, iron salts, alkali metal salts, alkaline earth metal salts, ammonium salts, and combinations thereof. In some embodiments the mixture of inorganic salts includes aluminum salts. In some embodiments, the molar percentage of the aluminum salts is at least 50%. In some embodiments, the aluminum salts include aluminum chloride. In some embodiments the molar percentage of aluminum chloride is at least 50%.

In some embodiments, the mixture of inorganic salts includes iron salts. In some embodiments the molar percentage of the iron salts is at least 50%. In some embodiments, the iron salts include ferric chloride. In some embodiments the molar percentage of ferric chloride is at least 50%.

In some embodiments, the mixture of inorganic salts includes anions chosen from the group consisting of halides, nitrates, nitrites, sulfates, sulfites, carbonates, hydroxides and combinations thereof.

In some embodiments the second metal is elemental aluminum, the first metal is elemental lithium, and the mixture of inorganic salts contains aluminum chloride, wherein the molar percentage of aluminum chloride is at least 50%. In some embodiments the second metal is elemental iron, the first metal is elemental lithium, and the mixture of inorganic salts contains aluminum chloride (AlCl₃) or ferric chloride (FeCl₃) or both. In some such embodiments, the sum of the molar percentages of aluminum chloride and ferric chloride is at least 50%.

In some embodiments the second metal is elemental iron, the first metal is elemental aluminum, and the mixture of inorganic salts contains aluminum chloride (AlCl₃) or ferric chloride (FeCl₃) or both. In some such embodiments, the sum of the molar percentages of aluminum chloride and ferric chloride is at least 50%.

In some embodiments, the conformable polymer is a block copolymer for which the first segments of the block copolymer comprise poly(oxyethylene)ₙ side chains, where n is an integer between 4 and 20, and the second segments of the block copolymer comprise poly(alkyl methacrylate). In some such embodiments the block copolymer is poly[(oxyethylene)₉ methacrylate]-b-poly(laurel methacrylate) (POEM-b-PLMA). In some such embodiments the ratio of POEM to PLMA is between 55:45 and 70:30 on a molar basis.

In some embodiments, the conformable polymer is a graft copolymer for which the first segments of the graft copolymer comprise poly(oxyethylene)ₙ side chains, where n is an integer between 4 and 20, and the second segments of the graft copolymer comprise poly(dimethyl siloxane). In some such embodiments, the graft copolymer is poly[(oxyethylene)₉ methacrylate]-g-poly(dimethyl siloxane).

In some embodiments the melting temperature of the molten salt electrolyte is less than 100° C. In some embodiments the melting temperature of the molten salt electrolyte is less than 75° C. In some embodiments the melting temperature of the molten salt electrolyte is less than 50° C. In some embodiments the melting temperature of the molten salt electrolyte is less than 30° C.

In preferred embodiments, a process for manufacturing an electropositive metal electrode includes:

(1) providing a conformable polymer coated conductive substrate, the conformable polymer coated conductive substrate being configured to selectively transport ions of the electropositive metal;

(2) providing an anode for an electrolytic cell, the anode providing a source of the electropositive metal ions;

(3) configuring the conformable polymer coated conductive substrate as a cathode in the electrolytic cell, the electrolytic cell containing the anode, and a molten salt electrolyte comprising a mixture of inorganic salts, wherein the melting temperature of the molten salt electrolyte is less than 140° C., and wherein the mixture of inorganic salts includes at least one ionic species having a higher reduction potential than the electropositive metal ion, wherein the molten salt electrolyte is disposed between the conformable polymer and the anode, and is in direct physical contact with both the conformable polymer and the anode, interposed between the anode and the conformable polymer coated conductive substrate; and

(4) applying a voltage across the anode and the conductive substrate, causing electrons to flow from the anode through an external circuit to the conductive substrate, and causing the electropositive metal ions to flow from the anode, through the molten salt electrolyte, through the conformable polymer coating, to the surface of the conductive substrate, to be reduced upon combining with the electrons, depositing a layer of the electropositive metal on the surface of the conductive substrate, sandwiched between the conductive substrate and the conformable polymer.

In some embodiments, the conformable polymer used in the process for manufacturing the electropositive metal electrode is a block or graft copolymer with first segments and second segments, each segment above its respective glass transition temperature, T_{g}, the first segments formed from groups configured to solvate the electropositive metal ion and the second segment being immiscible with the first segments. In some such embodiments the conformable polymer coated conductive substrate is prepared by a method including:

(1) preparing a coating solution by dissolving the block or graft copolymer in a cosolvent, each segment of the block or graft copolymer being separately soluble in the cosolvent;

(2) coating a conductive substrate with the coating solution; and

(3) evaporating the cosolvent from the coated conductive substrate so that the conductive substrate is coated with a layer of the block or graft copolymer.

In preferred embodiments, the anode used in the process for manufacturing an electropositive metal electrode is an electrode from a recycled battery, the recycled battery being chosen from the group consisting of an electropositive metal battery and an electropositive metal ion battery.

### BRIEF DESCRIPTION OF THE DRAWINGS

The foregoing features of embodiments will be more readily understood by reference to the following detailed description, taken with reference to the accompanying drawings, in which:

FIG. 1 illustrates the structural features of block and graft copolymers.

FIG. 2 embodies an electropositive metal battery constructed with a single conformable polymer coated negative electrode and a single positive electrode.

FIG. 3 embodies an electropositive metal battery constructed with a single conformable polymer coated negative electrode and two positive electrodes.

FIG. 4 shows steps for producing an electropositive metal electrode according to embodiments of the invention.

FIG. 5 shows an electrolytic cell for producing an electropositive metal electrode according to embodiments, prior to the application of electroplating current.

FIG. 6 shows the electrolytic cell of FIG. 5 after the application of electroplating current.

FIG. 7a provides a cross-sectional view of a conformable polymer coated conductive substrate prior to electroplating electropositive metal onto the substrate according to embodiments of the invention.

FIG. 7b provides a top view of a conformable polymer coated conductive substrate prior to electroplating electropositive metal onto the substrate according to embodiments of the invention.

FIG. 8a provides a cross-sectional view of the conductive substrate of FIGS. 7a and 7b after electroplating electropositive metal onto the substrate to form an electropositive metal layer sandwiched between the conductive substrate and the conformable polymer coating according to embodiments of the invention.

FIG. 8b provides a top view of the conductive substrate of FIG. 8a according to embodiments of the invention.

### DETAILED DESCRIPTION OF SPECIFIC EMBODIMENTS

Definitions. As used in this description and the accompanying claims, the following terms shall have the meanings indicated, unless the context otherwise requires:

A “metal displacement battery” as used herein refers to a rechargeable battery for which the negative electrode comprises a first metal and the positive electrode comprises a second metal, for which the first metal has a lower reduction potential, i.e., is more cathodic, than that of the second metal.

“Decrepitation” as used herein refers to the cracking of intercalation-type positive electrodes as a result of volume changes during repeated recycling.

An “electrolyte” is a material that conducts ionic charge.

A “solid electrolyte” is solid material that allows ion transport between electrodes of an electrolytic or galvanic cell. For the purposes of this application, a “solid electrolyte” is understood to include a material such as a gel, or a conformable polymer that has microscopic regions with liquid-like behavior, but that maintains its overall shape.

A “molten salt” is a mixture of salts above its melting point, the mixture present as a liquid phase that is ionically conductive. A “molten salt” is an electrolyte by virtue of its ionic conductivity.

An “ionic liquid” is a room-temperature molten salt. Exemplary ionic liquids have bulky organic cations such as the 1-ethyl-3-methylimidazolium (EMIM) cation, for example EMIM:Cl and EMIM:Ac (acetate anion).

An “inorganic molten salt” is an inorganic salt composition above its melting temperature. Exemplary inorganic molten salts include metal halides, e.g., sodium chloride (NaCl), and metal nitrates, e.g., silver nitrate (AgNO₃).

A “block copolymer” is a polymer with blocks made up of one monomer alternating with blocks of another monomer along a linear polymer strand.

A “graft copolymer” is a polymer which has a backbone strand made up of one type of monomer and branches of a second monomer.

As used herein, a “conformable polymer” is an amorphous elastomeric polymer above its glass transition temperature, capable of extensive molecular rearrangement, allowing the polymer to stretch and retract in response to macroscopic stress. When present as a coating on a substrate, such a conformable polymer has the mechanical properties of a solid, but can shrink and expand to adapt to volume changes of the substrate, while continuing to coat the substrate. The block and graft copolymers of the present invention are “conformable polymers.”

A “segment” is a block in the case of a block copolymer and a side chain or backbone in the case of a graft copolymer.

“Microphase separation” of a block or graft copolymer occurs when polymer chains segregate into domains so as to cluster according to the compositions of their monomeric units.

A “cosolvent” for different monomers is a solvent capable of dissolving each of the different segments of a block or graft copolymer.

A “common solvent” is identical with a “cosolvent.”

A “negative electrode” functions as an anode in a galvanic cell and as a cathode in an electrolytic cell.

A “positive electrode” functions as a cathode in a galvanic cell and as an anode in an electrolytic cell.

The “reduction potential” of a chemical species provides a measure in volts, of the tendency of the chemical species to undergo electrochemical reduction by accepting electrons. A higher reduction potential implies a greater tendency to accept electrons and be reduced. A metal that is more “noble” has a greater tendency to keep its electrons, and the cations of that metal have a higher reduction potential when compared to the cations of a metal that is less “noble.” For metals, less “noble” is synonymous with more electropositive.

A “bi-electrolyte electrochemical cell” as set forth herein is an electrochemical cell that incorporates both an inorganic molten salt electrolyte and an ion-selective SSE, the ion-selective SSE covering the negative electrode of the cell.

Lithium cation has one of the lowest, i.e., most negative and therefore most cathodic, reduction potentials of all metal cations. In other words, lithium is one of the most electropositive and least “noble” metals. Other highly electropositive metals include sodium, magnesium and aluminum.

The tendency for metal batteries to form dendrites can lead to electrical shorting across the cell. Such shorts can lead to fires and explosions, in particular for metal batteries that incorporate flammable organic electrolytes. Solid electrolytes in intimate contact with metal electrodes can limit dendrite formation, thereby extending battery life. Solid electrolytes are less flammable compared to organic electrolytes, and can be designed for ion selectivity. However, conventional solid electrolytes composed of ion-selective ceramic materials are fragile, brittle and prone to fracture due to volume changes in the adjoining electrodes during charging and discharging cycles. Moreover, the interface between solid electrolytes and electrode surfaces can provide a significant impedance barrier, reducing output voltage and hence battery efficiency.

The ideal solid electrolyte has the ion transport properties of a liquid, and the ability to preferentially transport desired ionic species, while blocking the undesirable transport of any other species including electrons. The ideal solid electrolyte is not flammable and is resistant to dendrite formation. The ideal solid electrolyte has the mechanical properties of a solid, but has elastomeric properties that allow it to accommodate electrode volume changes associated with battery charging and discharging while still maintaining physical contact with the electrode. As embodiments of the instant invention demonstrate, solid electrolytes of improved design, incorporating ion-selective conformable polymers, approach ideal solid electrolyte behavior.

In preferred embodiments of the instant invention, a block or graft copolymer is incorporated as an ion-selective conformable polymer solid-state electrolyte. According to some such embodiments, the block or graft copolymer has one or more “A” segments of more hydrophilic polymers capable of solvating electropositive metal salts, interspersed with one or more “B” segments of more hydrophobic polymers. All segments are above their respective glass transition temperatures, T_{g}. Material comprising such a block or graft copolymer will microphase separate into locally segregated nanoscale domains of “A” and “B” segments. The resultant ordering of segments in turn confers conformational rigidity to the material even though all of the constituents are segmentally liquid. For suitable A:B ratios, the A segments form continuous metal ion solvating channels. For metal ion solvating chains having suitably high local chain mobility, high electrical conductivity allows the directed flow of metal ions through the copolymer upon application of an electric field. Doping the copolymer with a salt of the electropositive metal of the negative electrode according to embodiments of the invention ensures selectivity for doped cations.

Inorganic molten salt electrolytes have excellent ionic conductivities and low flammability. However, due to their high melting points, molten salt electrolytes suitable for electropositive metal batteries are typically limited to dangerously high temperatures, under which conditions they can rapidly corrode conventional battery containment materials. Moreover, because the melting temperature of lithium metal is 180.5° C. and the melting temperature of sodium metal is 97.79° C. cells operating at such high temperatures can potentially leak highly reactive molten lithium and sodium metal. The use of ionic liquid electrolytes with melting temperatures below room temperature can overcome some of these problems, but typically include expensive organic ions, and have reduced charge transfer rates compared to those of inorganic molten salts.

Compositions of inorganic molten salts according to embodiments of the present invention have melting temperatures (Tins) below 140° C. In some embodiments, the inorganic molten salts have Tₘs below 100° C., below 80° C., below 60° C., below 40° C., below 30° C., below 10° C.

Molten salt compositions according to some embodiments of the present invention include salts of electropositive metals, including but not limited to Li, Na, K, Mg and Ca. Some embodiments include salts of more electronegative metals including but not limited to Ti, Fe, Ni, Bi, Pb, Zn, Sn, and Cu. Some embodiments include halometallate molten salt compositions. Some preferred embodiments include haloaluminate molten salt compositions of AlX₃, where X is a halide. In some embodiments, X is Cl, and the molten salts include chloroaluminate salts. Some inorganic molten salts include ammonium salts. Some preferred embodiments include haloferrate molten salt compositions of FeX₃. In some embodiments, X is Cl, and the molten salts include chloroferrate salts. For some embodiments, molten salt compositions include inorganic nitrate salts.

The molten salt electrolytes of the instant invention are non-flammable, and are liquid at temperatures well below the melting point of lithium, sodium, magnesium, and aluminum. Consequently, for embodiments of this invention, there is no danger from the leakage of liquid metal. At these temperatures, these molten salt electrolytes are also not significantly corrosive.

In embodiments of the instant invention, inorganic species are incorporated into the molten salts that have higher reduction potentials than the metal of the negative electrode. In these embodiments, the negative electrode of the electrochemical cell is protected with a layer solid electrolyte block or graft copolymer that has been doped with a salt of the negative electrode metal. Even though those species with higher reduction potentials would ordinarily electroplate in preference to the metal of the negative electrode, they are blocked from doing so by the layer of solid electrolyte copolymer, which preferentially transports dopant metal cation.

For such embodiments, the layer of ion-selective solid electrolyte block or graft copolymer allows the use of low Tₘ inorganic molten salt electrolytes that include ionic species with a higher reduction potential than that of the metal ion released during discharge from the negative electrode. When metal batteries are constructed according to embodiments of the invention with such copolymer coated negative electrodes and with a low Tₘ inorganic molten salt electrolyte between the copolymer and the positive electrode, the facile ion transport through liquid-like channels of the copolymer at the negative electrode, and the ability of the molten salt electrolyte to penetrate the pores of the positive electrode, provide a high energy density, low impedance barrier battery, with a significantly improved cycle life, reduced threat of dendrite formation, and enhanced safety profile. The ability of the copolymer coating to adjust to volume changes and to self-heal if damaged reduces the detrimental effects of such volume changes during cycling, further enhancing battery life.

Bi-electrolyte batteries with a more electropositive metal at the negative electrode and a more electronegative metal at the positive electrode can make use of cheap and abundant materials, e.g. sodium and iron, in contrast to batteries that use more expensive intercalation-type materials. Use of a second metal is further advantageous compared to intercalation materials, since the latter suffer from decrepitation, which leads to capacity fade. However, without an ion-selective barrier, the composition of inorganic molten salt electrolytes that can be used for such bimetallic batteries is limited to salts of metals that are more cathodic (electropositive) than the negative electrode metal. But because a metallic positive electrode must be less cathodic than the negative electrode metal, any metal ions released during charging from the positive electrode would preferentially plate onto the negative electrode, making such a cell suitable only for operation as a primary cell. However, with an ion-selective barrier, the cell can be recharged by plating the negative electrode metal. In the presence of such an ion-selective barrier, a broader range of inorganic molten salt compositions can be used, allowing for an assortment of positive electrode metals, and better control over the melting point of the inorganic molten salt.

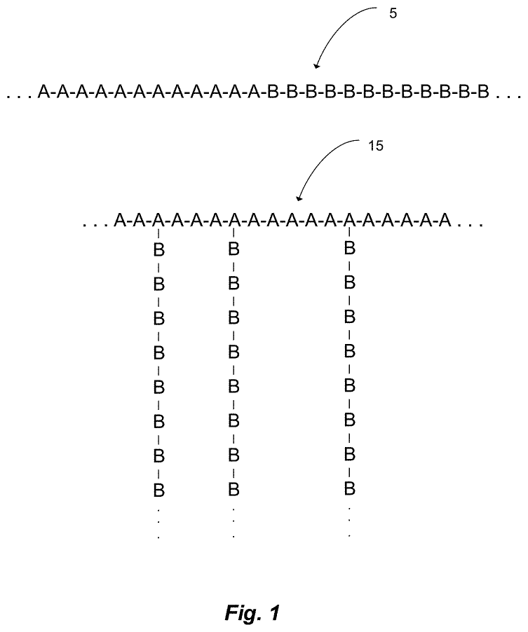

As illustrated in FIG. 1, block copolymers 5 of embodiments of the invention have alternating blocks of monomer units, here designated by type “A” and type “B” monomers. In contrast graft copolymers 15 of embodiments of the invention have a backbone made up of type “A” monomers and side-chains of type “B” monomers. The block copolymer 5 of FIG. 1 is a di-block polymer (AB) with one block of A and one block of B. In other embodiments, block copolymers can be tri-block (ABA or BAB) or multi-block copolymers.

Block copolymers with blocks of immiscible groups and graft copolymers with immiscible backbone and side-chain segments as embodied in this application provide a solid electrolyte with the ion transport properties of a liquid and with the ability to preferentially transport desired ionic species, while blocking the transport of undesirable species. The thus embodied solid electrolyte has low flammability and a resistance to dendrite formation. The thus embodied solid electrolyte is conformable, having the mechanical properties of a solid but being able to accommodate volume changes associated with negative electrodes while still maintaining physical contact with the electrode.

Consequently, block copolymers with blocks of immiscible groups and graft copolymers with immiscible backbone and side-chain segments as embodied in this application provide ion-selective, conformable polymer solid-state electrolytes with improved safety and performance, longer battery life, and resistance to dendrite formation. The use of such copolymers to protect the negative electrode of a rechargeable battery allows the use of low Tₘ molten salt electrolytes.

A block or graft copolymer as embodied in this application has one or more “A” segments of more hydrophilic metal salt solvating polymers interspersed with one or more “B” segments of more hydrophobic polymers. All segments are above their respective glass transition temperatures, T_{g}. Material incorporating such a block or graft copolymer will microphase separate into locally segregated nanoscale domains of “A” and “B” segments. The resultant ordering of segments in turn confers conformational rigidity to the material even though all of the constituents are segmentally liquid. For suitable A:B ratios, the A segments form continuous, selective, metal ion solvating channels. For metal ion solvating chains having suitably high local chain mobility, high metal ion conductivity allows the selective, directed flow of metal ions through the copolymer upon application of an electric field.

Dissolving the block or graft copolymer in a suitable common solvent (cosolvent) that is capable of dissolving both A and B segments allows ready processing of the polymer by conventional coating methods. For example, electrodes can be directly coated with block or graft copolymer electrolyte by dipping the electrode in a solution formed by dissolving the copolymer and the salt of an electropositive metal in the cosolvent and allowing the cosolvent to evaporate. Such an electrode can then be directly used in a battery or in an electrolytic cell. In this manner, as described below, electropositive metal electrodes can be coated with elastomeric, electropositive metal ion-selective conducting block or graft copolymer solid electrolytes for use in rechargeable batteries according to embodiments of the instant invention.

Suitable copolymers can be di-block copolymers (AB), tri-block copolymers (ABA or BAB), or higher multiblock polymers with alternating A and B blocks. All blocks are above their respective glass transition temperatures, T_{g}. Likewise suitable are graft copolymers with backbone A monomers and side-chain B monomers, or back-bone B monomers and side-chain A monomers. In some embodiments, the A segments incorporate short poly(oxyethylene)ₙ side chains, where n, the number of oxyethylene groups in the side chain ranges from 4 to 20, preferably between 7 and 11. In some embodiments n is equal to nine. In some embodiments the poly(oxyethylene)ₙ side chains are incorporated by polymerization of poly(oxyethylene)ₙ methacrylate monomers. In a preferred embodiment, the A segments are synthesized by polymerization of poly(oxyethylene)₉ methacrylate monomers.

In some embodiments, the B segments have alkyl side chains having from 4 to 12 carbons. In some embodiments, the B segments are synthesized from a poly(alkyl methacrylate). In some embodiments, the poly(alkyl methacrylate) is chosen from the group consisting of poly(butyl methacrylate), poly(hexyl methacrylate), and poly(laurel methacrylate). In a preferred embodiment, the poly(alkyl methacrylate) is poly(laurel methacrylate).

In some embodiments the “A” segments incorporate a mixture of neutral and anionic groups. In some such embodiments, the anionic groups are configured in order to minimize coordination of the anionic groups with metal cations.

In a preferred embodiment, the copolymer is the di-block copolymer poly[(oxyethylene)₉ methacrylate]-b-poly(laurel methacrylate) (POEM-b-PLMA).

In some embodiments, the block copolymers are synthesized by living anionic polymerization. In some embodiments, the block copolymers are synthesized by atom transfer radical polymerization (ATRP).

In some embodiments, the copolymer is a graft copolymer with a hydrophilic backbone of “A” segments that are metal salt solvating and hydrophobic side-chains of “B” segments made up of hydrophobic polymers. Each segment is above its respective glass transition temperature, T_{g}.

In a preferred embodiment, the copolymer is a graft copolymer with backbone “A” segments incorporating short poly(oxyethylene)ₙ side chains, where n, the number of oxyethylene groups in the side chain ranges from 4 to 20, preferably between 7 and 11. In some embodiments, n is equal to nine. In some embodiments, the poly(oxyethylene)ₙ side chains are incorporated by polymerization of poly(oxyethylene)ₙ methacrylate monomers. In a preferred embodiment, the A segments are synthesized by polymerization of poly(oxyethylene)₉ methacrylate monomers.

In some embodiments, the conformable polymer is a graft copolymer with side chain “B” segments incorporating poly(dimethyl siloxane) (PDMS). In a preferred embodiment, the graft copolymer is incorporated into a poly(oxyethylene)ₙ methacrylate backbone by random copolymerization of poly(dimethyl siloxane) monomethacrylate macromonomer (PDMSMA) with poly(oxyethylene)ₙ methacrylate monomers to form a graft copolymer of type POEM-g-PDMS. In preferred embodiments, poly(oxyethylene)₉ methacrylate monomers are reacted to form the POEM-g-PDMS copolymer.

In some embodiments, the “A” backbone includes additional monomers. In some embodiments the additional monomers are anionic. In an embodiment, poly(oxyethylene)₉ methacrylate monomers are copolymerized with methacrylate monomers (MAA) and with PDMSMA to form poly(oxyethylene)₉-ran-MAA-g-PDMS. In an embodiment, the carboxylic acid groups of this polymer are reacted with BF₃ to give anionic boron trifluoride esters, which have a reduced tendency to complex metal ions when compared with MAA carboxylate groups.

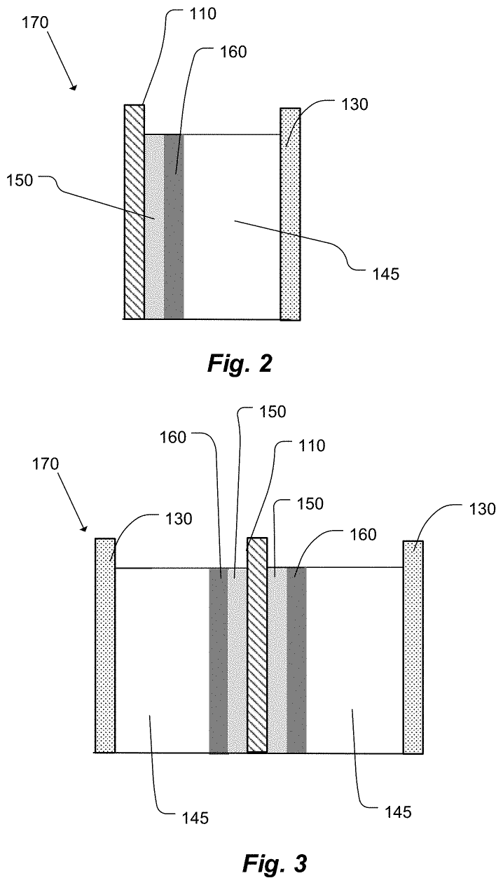

In the rechargeable battery 170 embodied in FIG. 2, the negative electrode is provided by a conductive substrate 110, which is coated with a layer of electropositive metal 150. Exemplary electropositive metals include lithium, sodium, magnesium, and aluminum. The layer of electropositive metal 150 is sandwiched between the conductive substrate 110 on a first side and an elastomeric SSE 160 on a second side. Opposite the elastomeric SSE 160 is a single positive electrode 130. Juxtaposed between the elastomeric SSE and the single positive electrode, and physically contacting both is a molten salt electrolyte 145. The positive electrode is constructed from a metal that is less electropositive than the metal of the negative electrode. Exemplary materials for the positive electrode include bismuth, lead, zinc, tin, and iron. The molten salt electrolyte 145 necessarily contains ions of the metals in the negative and positive electrodes.

In the rechargeable battery 175 embodied in FIG. 3, a single negative electrode includes a conductive substrate 110, the conductive substrate coated on all sides with a layer of electropositive metal 150. Exemplary electropositive metals include lithium, sodium, magnesium, and aluminum. The electropositive metal 150 is in turn sandwiched between a layer of elastomeric SSE 160. Two positive electrodes 130 are provided at opposite sides of the cell, with each being separated from the elastomeric SSE 160 by molten salt electrolyte, the molten salt electrolyte 145 physically contacting the elastomeric SSE 160. The positive electrodes are constructed from a metal that is less electropositive than the metal of the negative electrode. Exemplary materials for the positive electrode include bismuth, lead, zinc, tin, and iron. The molten salt electrolyte 145 necessarily contains ions of the metals in the negative and positive electrodes.

In preferred embodiments of the batteries of FIGS. 2 and 3, the elastomeric SSE is a copolymer solid electrolyte and a salt of the electropositive metal is dispersed within the copolymer. In some embodiments, the salt is the metal triflate, e.g., LiCF₃SO₃, NaCF₃SO₃, Mg(CF₃SO₃)₂, or Al(CF₃SO₃)₃. In some embodiments the salt is dispersed within the copolymer at a molar ratio of between 50:1 and 10:1 ethylene oxide to metal ion. In a preferred embodiment, the salt is dispersed within the copolymer at a molar ratio of 20:1 ethylene oxide to metal ion. In some embodiments, the copolymer with dispersed salt coating the negative electrode is formed by solution casting directly from anhydrous tetrahydrofuran (THF).

In embodiments of the batteries of FIGS. 2 and 3, the molten salt has a melting point (Tₘ) less than 140° C. In some embodiments, the molten salt 145 has a Tₘ less than 100° C. In some embodiments, the molten salt 145 has a Tₘ less than 75° C. In some embodiments, the molten salt 145 has a Tₘ less than 50° C. In some embodiments, the molten salt 145 has a Tₘ less than 30° C.

In some embodiments, the molten salt includes aluminum salts, wherein the molar percentage of aluminum salts is at least 50%. In some embodiments, the aluminum salts include aluminum chloride. In some embodiments, the mixture of inorganic salts includes anions chosen from the group consisting of halides, including chlorides, bromides, and iodides and mixtures of them, e.g., AlBrCl₂.

The batteries as embodied in FIGS. 2 and 3 are non-combustible and have long cycle lives. Because the batteries in FIGS. 2 and 3 operate at low temperature, only modest amounts of energy are required to melt the salts to form the molten salt electrolyte. Consequently, only a modest input of initial energy allows the battery to become operational. In an electric vehicle, such energy may, for example, be supplied by a conventional lead acid car battery of the type required to start an internal combustion engine. Once operational, the salts remain in the molten state due to resistance heating as current is passing.

The molten salts have excellent ionic conductivity and generally encounter little impedance at the interface with the positive electrode. Because of the presence of the copolymer membrane doped with a salt of the electropositive metal, molten salt electrolytes can include cations having a greater reduction potential (more anodic) than that of the electropositive metal. Such cations will be blocked from reaching the negative electrode surface by the elastomeric SSE and will thus not compete with electropositive ion for reduction at that surface. Moreover, the elastomeric SSE inhibits dendrite formation, further enhancing the cycle life of the battery.

In summary, the combination of low Tₘ molten salt electrolytes and elastomeric SSE architecture of the instant invention provides batteries as embodied in FIGS. 2 and 3 that are safe, efficient, have long cycle lives, and require minimal energy for startup.

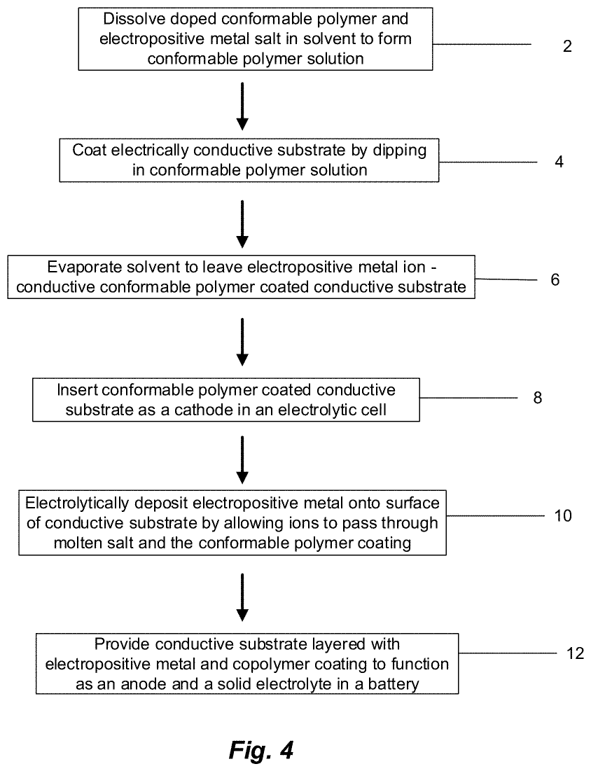

As summarized by the manufacturing steps shown in FIG. 4, in some embodiments a copolymer coated electropositive metal electrode is manufactured and inserted along with a positive electrode, itself a metal that undergoes an exchange reaction with the molten salt, into a rechargeable cell to form a metal displacement battery, with the electropositive metal electrode providing a negative electrode and the copolymer providing an elastomeric SSE.

The steps of this embodiment are as follows: first, prepare the selective electropositive ion conductive block or graft copolymer solution by dissolving the block or graft copolymer with a metal salt of the electropositive metal of the negative electrode in a cosolvent capable of dissolving both A and B segments 2. For example, a sodium-ion selective block or graft copolymer solution can be prepared by dissolving the copolymer with sodium triflate (NaCF₃SO₃) in tetrahydrofuran (THF). Similarly, a lithium, magnesium, or aluminum selective block or graft copolymer can be prepared by dissolving the copolymer with the triflate salts of lithium, magnesium, or aluminum, respectively. Second, coat an electrically conductive substrate with the selective electropositive ion-conductive copolymer by dipping the substrate in the copolymer solution 4. Third, evaporate the cosolvent to leave the ionically conductive substrate coated with copolymer 6. Next, insert the copolymer-coated conductive substrate as a cathode in an electrolytic cell, the electrolytic cell including an anode, the anode providing a source of electropositive metal, and a molten salt electrolyte 8. Then, apply voltage across the anode and the substrate, acting as a cathode, causing electrons to flow from the anode through an external circuit to the conductive substrate, causing electropositive ions to be pulled from the anode through the molten salt electrolyte, and further to be selectively pulled through the copolymer coating, to be reduced at the substrate surface, thereby electrolytically plating electropositive metal onto the surface 10. As the electropositive metal plates, the copolymer coating adjusts to continue to cover the growing layer of electropositive metal, resulting in a final product for which the substrate is coated with a layer of electropositive metal, and the layer of electropositive metal is in turn coated with a layer of copolymer solid electrolyte. In the final step, the conductive substrate layered with electropositive metal and the copolymer solid electrolyte is inserted as the combined electropositive metal negative electrode and solid electrolyte in an electropositive metal battery 12.

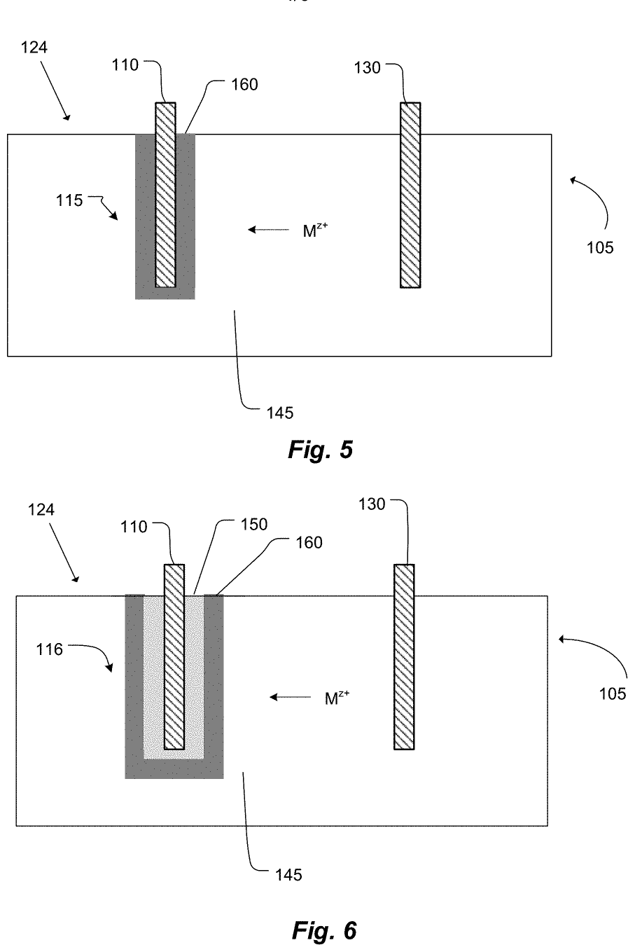

FIGS. 5 and 6 embody an electrolytic cell 124 suitable for the production of an electropositive metal electrode according to the process of FIG. 4. A conductive substrate 110 that has been coated with elastomeric SSE 160 is inserted as the cathode of an electrolytic cell and immersed into a molten salt electrolyte 145 juxtaposed between the elastomeric SSE 160 and an anode 130 at the opposite end of the cell 124. The anode 130 provides a source of ions (M^{z+}) of the electropositive metal and can, for example, be a metal electrode or an intercalated ion electrode from a recycled battery. As shown in FIG. 6, as the cell operates, an external voltage causes electrons to move from the anode 130 to the conductive substrate. Electropositive ions released from the anode traverse the molten salt, selectively move through the copolymer 160, and combine with electrons on the surface of the conductive substrate 110 to electroplate electropositive metal 150 on the surface of the conductive substrate 110. As this process occurs, the copolymer coating 160 adjusts to volume changes and continues to coat the growing layer of electropositive metal 150. In this manner, a copolymer coated electropositive metal electrode is obtained that can be used to make an electropositive metal battery.

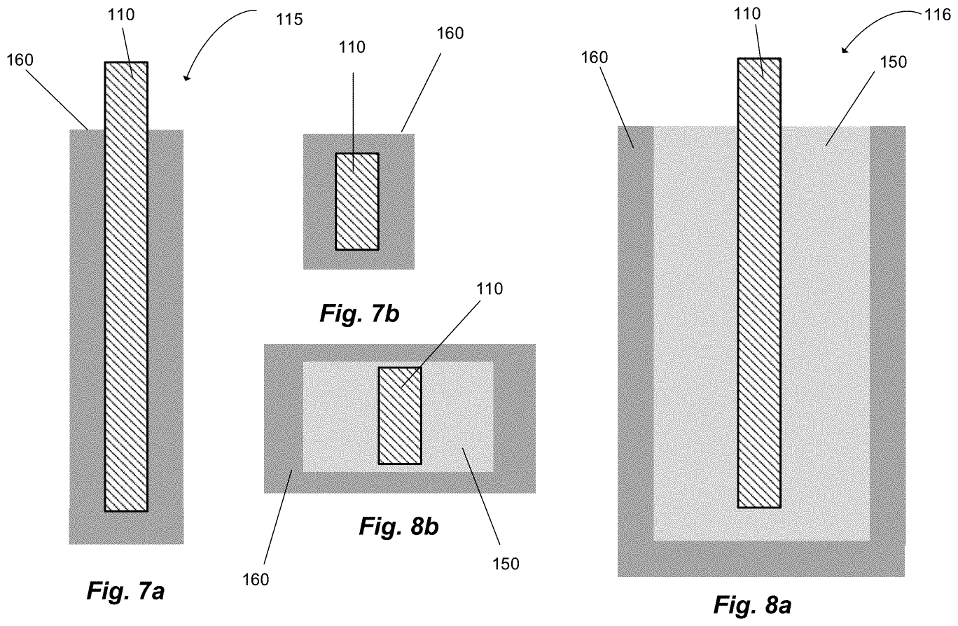

FIG. 7a shows a cross-section and FIG. 7b shows a top view of a copolymer coated electrically conductive substrate 110 according to embodiments of the invention. Following the process of dipping the electrically conductive substrate 110 into a cosolvent solution of copolymer and drying, the centrally located electrically conductive substrate 110 is surrounded by a layer of elastomeric SSE 160. FIG. 8a shows a cross-section and FIG. 8b shows a top view of the elastomeric SSE coated electropositive metal electrode that can be obtained following the electrolytic plating onto the electrically conductive substrate 110 of a layer of electropositive metal 150 which fills the space between the conductive substrate 110 and the elastomeric SSE 160.

The method of FIG. 4, as embodied in FIGS. 5 and 6, allows for the efficient and selective plating of electropositive metal in the presence of ions of more noble metallic species and thereby allows for the recovery of electropositive metal from impure sources of electropositive metal and the efficient recycling of electropositive metal from, for example, lithium ion and lithium metal batteries.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A rechargeable metal displacement battery comprising:
a negative electrode, the negative electrode having a conductive substrate coated with a layer of a first metal, the layer of the first metal having an inner face and an outer face, the inner face contacting the conductive substrate;
a positive electrode, the positive electrode comprising a second metal;
a solid electrolyte comprising a conformable polymer that preferentially conducts ions of the first metal compared to ions of the second metal, and that coats the outer face of the layer of the first metal;
a molten salt electrolyte, the molten salt electrolyte being a mixture of inorganic salts including a first salt of the first metal and a salt of the second metal, wherein the melting temperature of the molten salt electrolyte is less than 140° C.,
wherein the molten salt electrolyte is disposed between the solid electrolyte and the positive electrode, and is in direct physical contact with both the solid electrolyte and the positive electrode, and
wherein the first metal is more electropositive than the second metal.

2. The rechargeable metal displacement battery of claim 1, wherein the conformable polymer is a graft or block copolymer with a first segment and a second segment, each segment above its respective glass transition temperature, T_{g}, the first segment formed from groups configured to solvate a second salt of the first metal and the second segment being immiscible with the first segment, and wherein the second salt of the first metal is dispersed within the solid electrolyte.

3. The rechargeable metal displacement battery of claim 1, wherein the first metal is selected from the group consisting of an alkali metal, an alkaline earth metal, and aluminum.

4. The rechargeable metal displacement battery of claim 1, wherein the second metal is selected from the group consisting of Fe, Ni, Bi, Pb, Zn, Sn, and Cu.

5. The rechargeable metal displacement battery of claim 1, wherein the mixture of inorganic salts includes one or more salts selected from the group consisting of aluminum salts, titanium salts, iron salts, alkali metal salts, alkaline earth metal salts, ammonium salts, and combinations thereof.

6. The rechargeable metal displacement battery of claim 1, wherein the mixture of inorganic salts includes aluminum salts, and wherein the molar percentage of the aluminum salts is at least 50%.

7. The rechargeable metal displacement battery of claim 1, wherein the mixture of inorganic salts includes iron salts, and wherein the molar percentage of the iron salts is at least 50%.

8. The rechargeable metal displacement battery of claim 1, wherein the mixture of inorganic salts includes anions chosen from the group consisting of halides, nitrates, nitrites, sulfates, sulfites, carbonates, hydroxides, and combinations thereof.

9. The rechargeable metal displacement battery of claim 1, wherein the mixture of inorganic salts includes aluminum chloride, wherein the molar percentage of aluminum chloride is at least 50%.

10. The rechargeable metal displacement battery of claim 1, wherein the mixture of inorganic salts includes ferric chloride, wherein the molar percentage of ferric chloride is at least 50%.

11. The rechargeable metal displacement battery of claim 1 wherein the second metal is elemental aluminum, the first metal is elemental lithium, and the mixture of inorganic salts contains aluminum chloride, wherein the molar percentage of aluminum chloride is at least 50%.

12. The rechargeable metal displacement battery of claim 1 wherein the second metal is elemental iron, the first metal is elemental lithium, and the mixture of inorganic salts contains aluminum chloride (AlCl₃) and ferric chloride (FeCl₃), wherein the sum of the molar percentages of aluminum chloride and ferric chloride is at least 50%.

13. The rechargeable metal displacement battery of claim 1 wherein second metal is elemental iron, the first metal is elemental aluminum, and the mixture of inorganic salts contains aluminum chloride (AlCl₃) and ferric chloride (FeCl₃), wherein the sum of the molar percentages of aluminum chloride and ferric chloride is at least 50%.

14. The rechargeable metal displacement battery of claim 2 wherein the conformable polymer is a block copolymer.

15. The rechargeable metal displacement battery of claim 2 wherein the conformable polymer is a graft copolymer.

16. The rechargeable metal displacement battery of claim 2 wherein the first segments of the block or graft copolymer comprise poly(oxyethylene)ₙ side chains, where n is an integer between 4 and 20.

17. The rechargeable metal displacement battery of claim 14 wherein the first segments of the block copolymer comprise poly(oxyethylene)ₙ side chains, where n is an integer between 4 and 20, and the second segments of the block copolymer comprise poly(alkyl methacrylate).

18. The rechargeable metal displacement battery of claim 15 wherein the first segments of the graft copolymer comprise poly(oxyethylene)ₙ side chains, where n is an integer between 4 and 20, and the second segments of the graft copolymer comprise poly(dimethyl siloxane).

19. The rechargeable metal displacement battery of claim 17, the block copolymer being poly[(oxyethylene)₉ methacrylate]-b-poly(laurel methacrylate) (POEM-b-PLMA).

20. The rechargeable metal displacement battery of claim 18, the graft copolymer being poly[(oxyethylene)₉ methacrylate]-g-poly(dimethyl siloxane).

21. The rechargeable metal displacement battery of claim 19 wherein the ratio of POEM to PLMA is between 55:45 and 70:30 on a molar basis.

22. The rechargeable metal displacement battery of claim 1 wherein the melting temperature of the molten salt electrolyte is less than 100° C.

23. The rechargeable metal displacement battery of claim 1 wherein the melting temperature of the molten salt electrolyte is less than 75° C.

24. The rechargeable metal displacement battery of claim 1 wherein the melting temperature of the molten salt electrolyte is less than 50° C.

25. The rechargeable metal displacement battery of claim 1 wherein the melting temperature of the molten salt electrolyte is less than 30° C.

26. A process for manufacturing an electropositive metal electrode comprising:
providing a conformable polymer coated conductive substrate, the conformable polymer coated conductive substrate being configured to selectively transport ions of the electropositive metal;
providing an anode for an electrolytic cell, the anode providing a source of the electropositive metal ions;
configuring the conformable polymer coated conductive substrate as a cathode in the electrolytic cell, the electrolytic cell containing the anode, and a molten salt electrolyte comprising a mixture of inorganic salts, wherein the melting temperature of the molten salt electrolyte is less than 140° C., and wherein the mixture of inorganic salts includes at least one ionic species having a higher reduction potential than the electropositive metal ion;
wherein the molten salt electrolyte is disposed between the conformable polymer and the anode, and is in direct physical contact with both the conformable polymer and the anode, interposed between the anode and the conformable polymer coated conductive substrate;
applying a voltage across the anode and the conductive substrate, causing electrons to flow from the anode through an external circuit to the conductive substrate, and causing the electropositive metal ions to flow from the anode, through the molten salt electrolyte, through the conformable polymer coating, to the surface of the conductive substrate, to be reduced upon combining with the electrons, depositing a layer of the electropositive metal on the surface of the conductive substrate, sandwiched between the conductive substrate and the conformable polymer.

27. A process according to claim 26, wherein the conformable polymer is a block or graft copolymer with first segments and second segments, each segment above its respective glass transition temperature, T_{g}, the first segments formed from groups configured to solvate the electropositive metal ion and the second segment being immiscible with the first segments.

28. A process according to claim 27, wherein the conformable polymer coated conductive substrate is prepared by a method including:
preparing a coating solution by dissolving the block or graft copolymer in a cosolvent, each segment of the block or graft copolymer being separately soluble in the cosolvent;
coating a conductive substrate with the coating solution;
evaporating the cosolvent from the coated conductive substrate so that the conductive substrate is coated with a layer of the block or graft copolymer.

29. A process according to claim 26, wherein the anode comprises an electrode from a recycled battery, the recycled battery being chosen from the group consisting of an electropositive metal battery and an electropositive metal-ion battery.

30. An electropositive metal electrode coated with electropositive metal ion-conductive copolymer manufactured according to the process of claim 27.

31. The electropositive metal electrode of claim 30, wherein the electropositive metal ion-conductive copolymer is a block copolymer.

32. The electropositive metal electrode coated with an electropositive metal ion-conductive copolymer according to claim 30, wherein the electropositive metal ion-conductive copolymer is a graft copolymer.

33. The electropositive metal electrode coated with an electropositive metal ion-conductive copolymer according to claim 30, wherein the first segments comprise poly(oxyethylene)ₙ side chains, where n is an integer between 4 and 20.

34. The electropositive metal electrode coated with an electropositive metal ion-conductive block copolymer according to claim 31, wherein the second segments comprise poly(alkyl methacrylate).

35. The electropositive metal electrode coated with electropositive metal ion-conductive graft copolymer according to claim 32, wherein the second chains comprise poly(dimethyl siloxane).

36. The electropositive metal electrode coated with electropositive metal ion-conductive block copolymer according to claim 31, the electropositive metal ion-conductive copolymer being poly[(oxyethylene)₉ methacrylate]-b-poly(laurel methacrylate) (POEM-b-PLMA).

37. The electropositive metal electrode coated with electropositive metal ion-conductive graft copolymer according to claim 32, the electropositive metal ion-conductive copolymer being poly[(oxyethylene)₉ methacrylate]-g-poly(dimethyl siloxane).

38. The electropositive metal electrode coated with electropositive metal ion-conductive copolymer according to claim 36, wherein the ratio of POEM to PLMA is between 55:45 and 70:30 on a molar basis.
